(19) United States
(12) Patent Application Publication
(10) Pub. No.: US 2026/0204840 A1
(43) Pub. Date: Jul. 16, 2026

(54) POWER CORD FEMALE CONNECTOR HAVING BUILT-IN LOCKING MECHANISM

(71) Applicant: HANGZHOU QIWANG TECHNOLOGY CO., LTD., HANGZHOU (CN)

(72) Inventors: GUOQIANG ZHU, HANGZHOU (CN); HUAIGEN LI, HANGZHOU (CN)

(21) Appl. No.: 19/031,028

(22) Filed: Jan. 17, 2025

(30) Foreign Application Priority Data
Jan. 13, 2025 (CN) 202520064372.4

(51) Int. Cl. H01R 13/629; H01R 13/11; H01R 24/22

(52) U.S. Cl. CPC H01R 13/62927; H01R 13/113; H01R 13/62911; H01R 24/22

(57) ABSTRACT

A power cord female connector includes a casing, at least one receptacle terminal for receiving at least one prong from a male connector, and a built-in locking mechanism for securing the at least one prong of the male connector to the at least one receptacle terminal, the built-in locking mechanism includes a control component having a top portion and a bottom portion connected to the top portion, and a locking component having at least one jaw, wherein, when the control component is in a locked position, the bottom portion of the control component pushes the at least one jaw against the at least one prong so as to secure the at least one prong in the at least one receptacle terminal.

### CROSS REFERENCE TO RELATED APPLICATION(S)

The present disclosure claims the benefit of and priority to Chinese Patent Application No. 202520064372.4, filed with the Chinese Patent Office on January 13, 2025, titled “Power Cord Female Connector,” the entire contents of which are incorporated herein by reference.

### FIELD

Examples of the present disclosure generally relate to electrical power cord, and in particular to a power cord female connector having a built-in locking mechanism.

### BACKGROUND

Power extension cords are essential tools that allow users to extend the reach of electrical outlets to various locations, making it convenient to power both indoor and outdoor devices and equipment. They are particularly useful in areas where standard outlets are difficult to access, such as remote locations of a room, outdoor spaces, or work areas. Often times, multiple power extension cords are linked together to reach distant power sources. However, these connections are susceptible to accidental or unintended disconnections, often caused by pulling or tugging, resulting in power interruptions.

Thus, solutions for a robust and secure connection between power extension cords are desired.

The present disclosure relates to a power cord female connector having a built-in locking mechanism substantially as shown in and/or described in connection with at least one of the figures, as set forth more completely in the claims.

According to one aspect of the present disclosure, a power cord female connector includes: a casing, at least one receptacle terminal for receiving at least one prong from a male connector, and a built-in locking mechanism for securing the at least one prong of the male connector to the at least one receptacle terminal, the built-in locking mechanism includes a control component having a top portion and a bottom portion connected to the top portion, a locking component having at least one jaw, wherein, when the control component is in a locked position, the bottom portion of the control component pushes the at least one jaw against the at least one prong so as to secure the at least one prong in the at least one receptacle terminal.

According to another aspect of the present disclosure, a power cord includes: a power cable and a female connector coupled to the power cable, wherein the female connector includes a casing; at least one receptacle terminal, provided in the casing, for receiving at least one prong from a male connector; a built-in locking mechanism, provided in the casing, for securing the at least one prong of the male connector to the at least one receptacle terminal, the built-in locking mechanism comprising: a control component having a top portion and a bottom portion connected to the top portion; a locking component having at least one jaw; wherein, when the control component is in a locked position, the bottom portion of the control component pushes the at least one jaw against the at least one prong so as to secure the at least one prong in the at least one receptacle terminal.

According to yet another aspect of the present disclosure, a power cord female connector includes: a casing; a pair of receptacle terminals, provided in the casing, for receiving a pair of prongs of a male connector; a built-in locking mechanism, provided in the casing, for securing the pair of prongs to the pair of receptacle terminals, the built-in locking mechanism comprising: a switch panel fitted in an aperture on the casing; a control component having a top portion and a bottom portion connected to the top portion through a shaft, the top portion situated above the switch panel, the bottom portion situated below the switch panel, the shaft being fitted in a sliding slot of the switch panel; a locking component having a pair of jaws connected by a connecting member; a base tray housing the pair of receptacle terminals, the locking component, and the bottom portion of the control component; wherein, when the control component is in a locking position, a pair of locking arms of the bottom portion pushes the pair of jaws of the locking component against the pair of prongs so as to secure the pair of prongs of the male connector in the receptacle terminals.

### BRIEF DESCRIPTION OF THE DRAWINGS

The appended drawings illustrate a number of example implementations and are a part of the present disclosure. Together with the following description, these drawings demonstrate and explain various principles of the present disclosure. It is to be noted, however, that the appended drawings illustrate only typical example implementations and are therefore not to be considered limiting of its scope.

FIG. 1A illustrates a perspective view of a female connector (plug) of a power extension cord, in accordance with an example implementation of the present disclosure.

FIG. 1B illustrates a schematic exploded view of the female connector shown in FIG. 1A, in accordance with an example implementation of the present disclosure.

FIG. 2A illustrates a schematic exploded view of the built-in locking mechanism shown in FIGS. 1A and 1B, in accordance with an example implementation of the present disclosure.

FIG. 2B illustrates another schematic exploded view of the built-in locking mechanism shown in FIGS. 1A and 1B, in accordance with an example implementation of the present disclosure.

FIG. 3A illustrates a schematic view of portions of the built-in locking mechanism in an unlocked position, in accordance with an example implementation of the present application.

FIG. 3B illustrates a schematic view of portions of the built-in locking mechanism in a locked position, in accordance with an example implementation of the present application.

FIG. 4A illustrates a schematic view of a male connector and portions of the built-in locking mechanism of the female connector shown in FIGS. 1A and 1B in an unlocked state, in accordance with example implementations of the present disclosure.

FIG. 4B illustrates a schematic view of a male connector and portions of the built-in locking mechanism of the female connector shown in FIGS. 1A and 1B in a locked state, in accordance with example implementations of the present disclosure.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the drawings. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described. Rather, the present disclosure covers all modifications, equivalents, and alternatives falling within the scope of the appended claims.

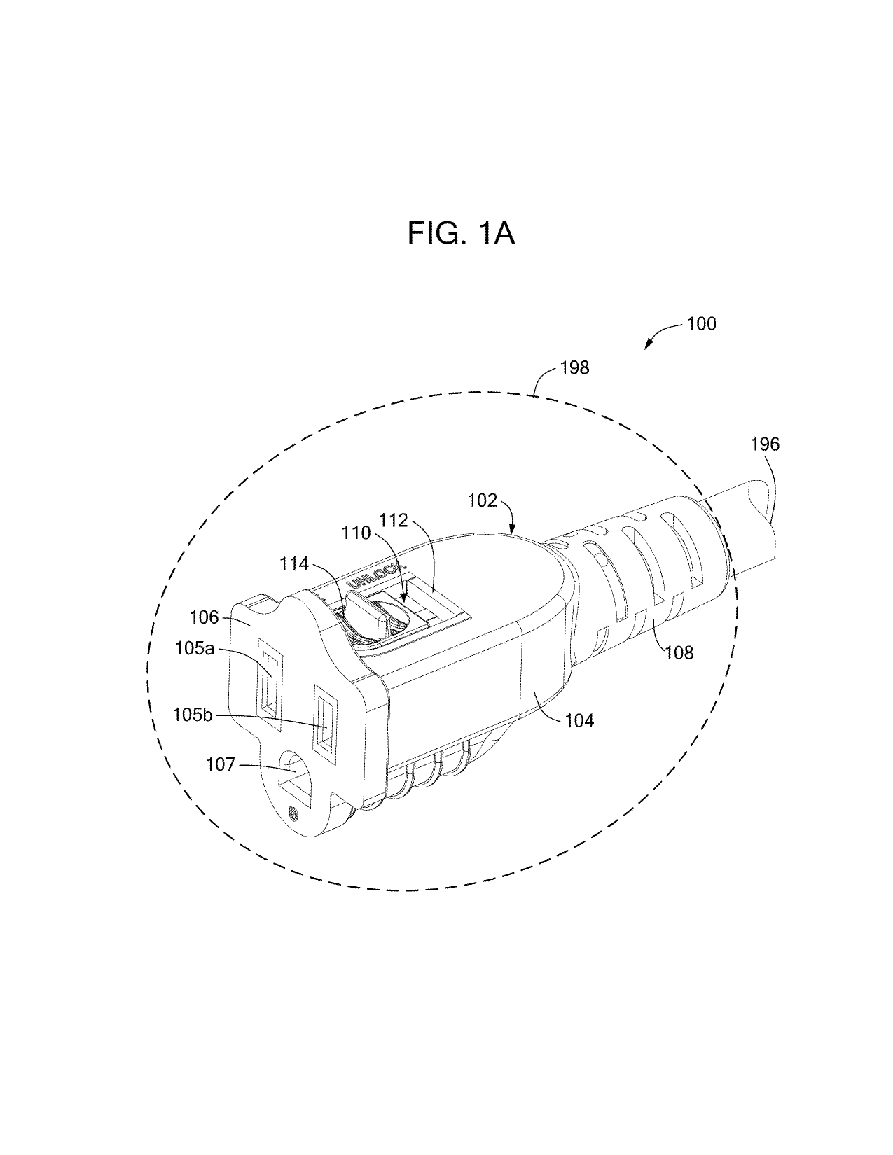

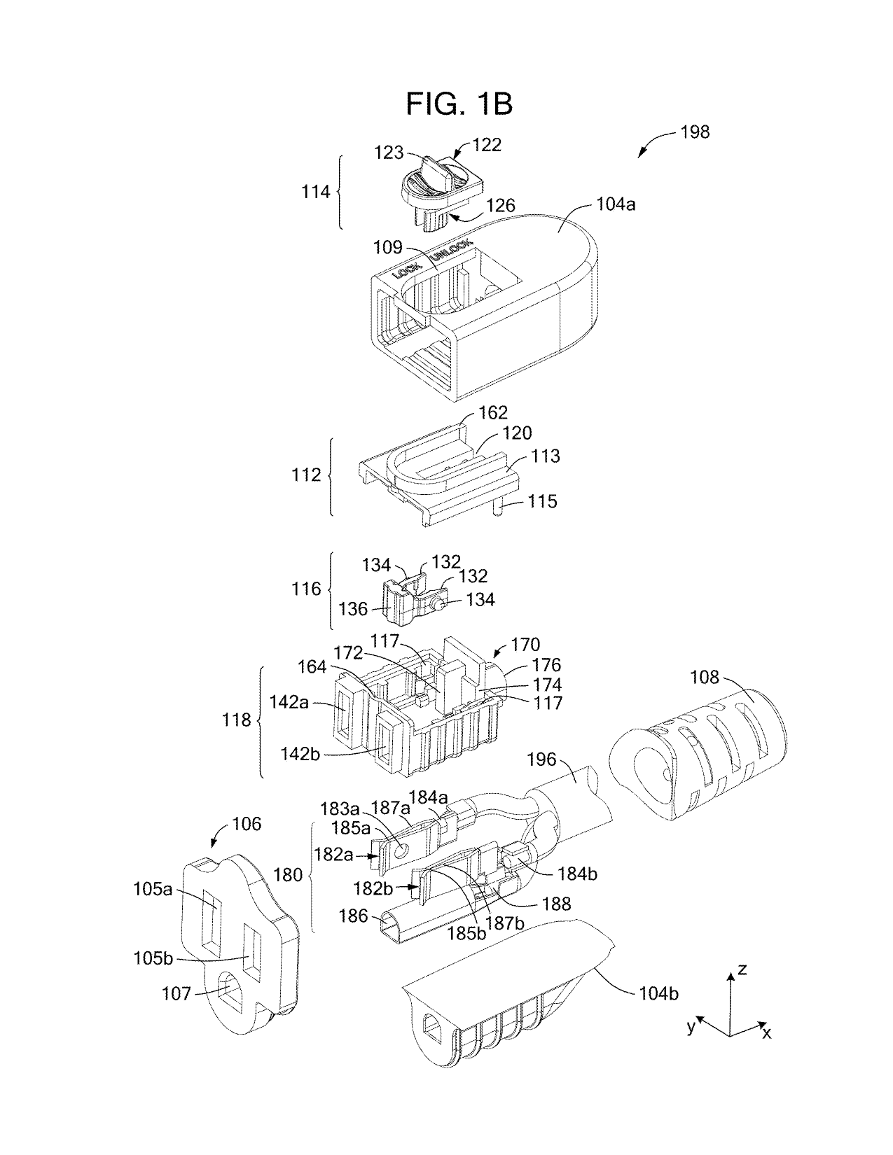

FIG. 1A illustrates a perspective view of a female connector (plug) 198 of a power extension cord 100, in accordance with an example implementation of the present disclosure. FIG. 1B illustrates a schematic exploded view of the female connector 198 shown in FIG. 1A, in accordance with an example implementation of the present disclosure.

As illustrated in FIGS. 1A and 1B, the power extension cord 100 includes the female connector 198 coupled to a power cable 196. It should be understood that the power extension cord 100 also includes a male connector (not explicitly shown in FIGS. 1A and 1B) coupled to the power cable 196 on the opposite end. The female connector 198 is configured to receive prongs from a male connector of another power extension cord or a power plug of an electronic device (not explicitly shown in FIGS. 1A and 1B).

As illustrated in FIG. 1A, the female connector 198 includes a connector body 102 having a casing 104 and a front plate 106. The female connector 198 also includes a guard sleeve 108 for providing rigidity and protection at the connection point between the connector body 102 (e.g., at a rear opening) and the power cable 196.

As illustrated in FIGS. 1A and 1B, the casing 104 includes an upper casing 104a and a lower casing 104b. The front plate 106 includes a pair of openings (or slots) 105a and 105b. For example, the opening 105a is configured to receive the neutral prong (e.g., the wider prong) of a male connector (not explicitly shown), and the opening 105b is configured to receive the hot prong (e.g., the narrower prong) of the male connector. The front plate 106 also includes a ground opening (or slot) 107 for receiving a ground prong from the male connector. The upper casing 104a, the lower casing 104b, and the front plate 106 together at least partially enclose the internal components of the female connector 198. According to implementations of the present disclosure, each of the casing 104, the front plate 106, and the guard sleeve 108 is made of an electrically insulating material.

As illustrated in FIGS. 1A and 1B, the connector body 102 includes a built-in locking mechanism 110 for securing or locking, for example, the prongs (e.g., the neutral and hot prongs) of a male connector (not explicitly shown) when inserted. The built-in locking mechanism 110 includes a switch panel 112, a control component (or switch) 114, a locking component 116, and a base tray 118. In the present implementation, each of the switch panel 112, the control component (or switch) 114, the locking component 116, and the base tray 118 is made of an electrically insulating material.

The switch panel 112 includes a support deck 113, a pair of positioning pillars 115, a guard rail 162, and a sliding slot 120. The guard rail 162 is positioned on the support deck 113, and includes an arched contour that substantially confirms to an arch-shaped aperture 109 in the ceiling of the upper casing 104a.

When assembled, the top surface of the support deck 113 that is not surrounded by the guard rail 162 rests against the inner ceiling of the upper casing 104a. The guard rail 162 on the support deck 113 is fitted through the arch-shaped aperture 109, and protrudes from the ceiling of the upper casing 104a.

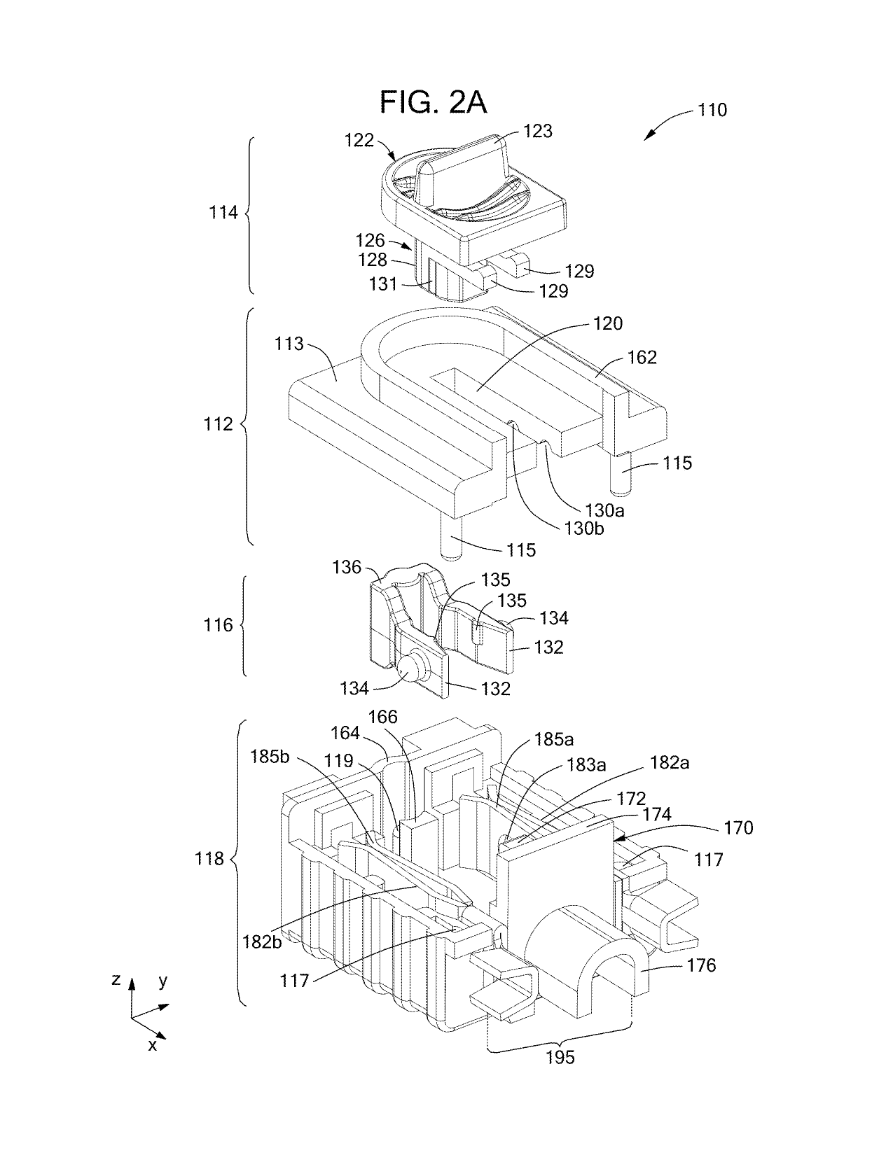

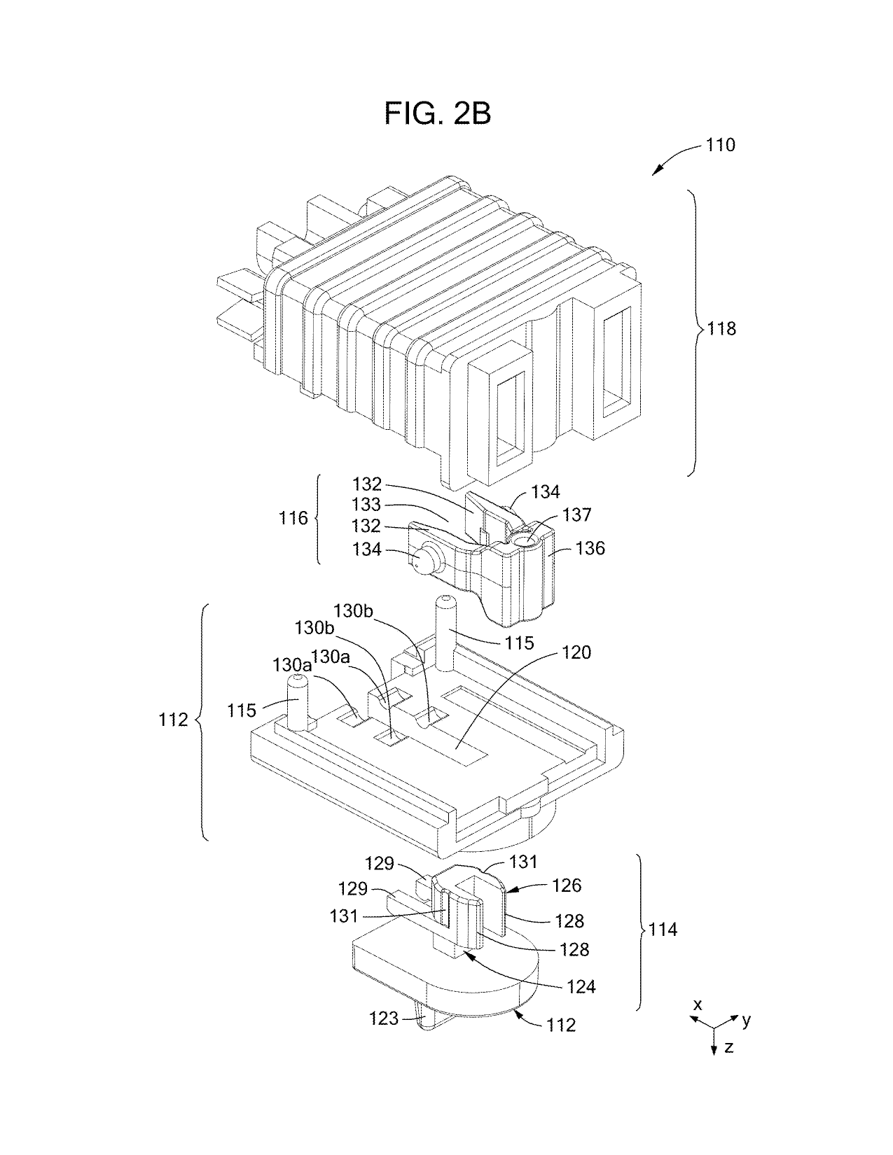

When assembled, the positioning pillars 115 are fitted into and received by a pair of holders 117 (shown in FIG. 2A) in the back corners of the base tray 118 to support and properly position (e.g., align) the switch panel 112 relative to the base tray 118.

The sliding slot 120 extends through the entire thickness of the support deck 113, and has a substantially rectangular shape. The sliding slot 120 allows the control component 114 to slide along the longitudinal direction (e.g., the x-direction) of the connector body 102.

The control component 114 includes a top portion 122 and a bottom portion 126 connected to the top portion 122 through a shaft 124 (as shown in FIG. 2B). When assembled, the top portion 122 of the control component 114 is situated on the support deck 113 of the switch panel 112 within the guard rail 162. The shaft 124 has a rectangular cross-section, and is fitted vertically through the sliding slot 120 of the switch panel 112. The bottom portion 126 of the control component 114 is situated below the switch panel 112 within the interior space of the base tray 118.

The top portion 122 includes a control knob 123. The position of the control component 114 can be adjusted by moving (or sliding) the control knob 123 in the sliding slot 120. In the present implementation, the control component 114 can be switched between two resting positions.

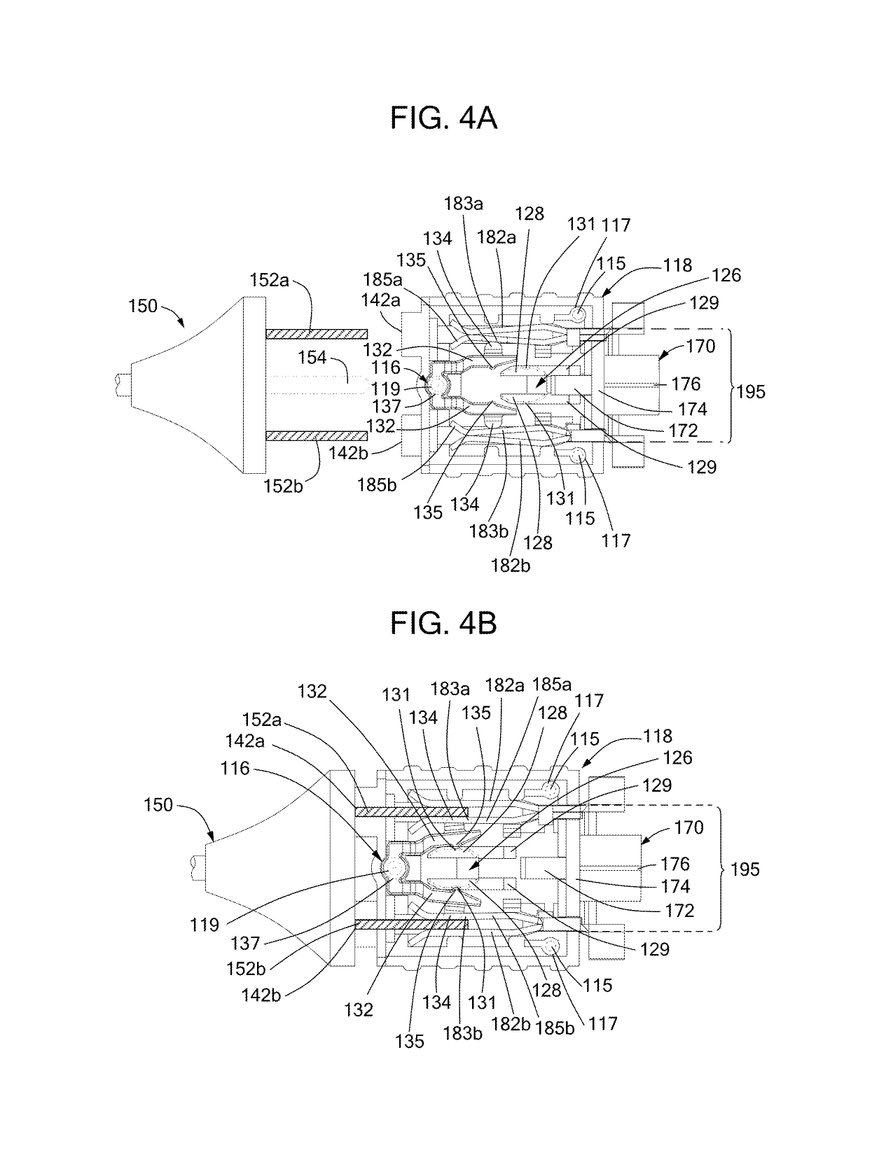

The first resting position (e.g., an unlocked position) of the control component 114 is farther away from the front plate 106 and closer to the guard sleeve 108 (e.g., along the x-axis). For example, a user can use his/her thumb to move or pull the control knob 123 backward in the direction away from the front plate 106. When the control component 114 is in the first resting position, the built-in locking mechanism 110 is in an unlocked state, where the locking component 116 of the built-in locking mechanism 110 situated inside of the casing 104 is not engaged with the receptacle terminals (e.g., receptacle terminals 182a and 182b shown in FIG. 4A) and the male connector prongs inside the connector body 102.

The second resting position (e.g., an locked position) of the control component 114 is closer to the front plate 106 and farther away from the guard sleeve 108 (e.g., along the x-axis). For example, a user can use his/her thumb to move or push the control knob 123 forward in the direction of the front plate 106. When the control component 114 is in the second resting position, the built-in locking mechanism 110 is in a locked state, where the locking component 116 of the built-in locking mechanism 110 situated inside of the casing 104 is engaged with the receptacle terminals (e.g., receptacle terminals 182a and 182b shown in FIG. 4B) and the male connector prongs inside the connector body 102 to secure the male connector prongs.

The locking component 116 includes a pair of jaws (or arms) 132 coupled to a connecting member 136. The connecting member 136 includes a recess and a specific outer shape that can, independently or collectively, facilitate the secure attachment of the locking component 116 to the base tray 118.

Each of the jaws 132 includes a protrusion (e.g., a bump) 134 on the exterior or outer surface thereof. In the present implementation, the jaws 132 are subject to elastic deformation when a pair of locking arms of the bottom portion 126 of the control component 114 is inserted into the space (or opening) between the jaws 132. The jaws 132 can elastically bend outwards (away from each other). As a result, the protrusions 134 are pressed against the male connector prongs and firmly secure the prongs in the receptacle terminals.

The base tray 118 includes a tray for housing the bottom portion 126 of the control component 114, the locking component 116, a pair of receptacle terminals 182a and 182b of an electrical receptacle portion 180, and a back plate 170.

The base tray 118 includes a front wall 164, and two front openings 142a and 142b on the front wall 164. The front openings 142a and 142b are respectively aligned with the openings 105a and 105b of the front plate 106. The base tray 118 also includes a back opening (e.g., a back opening 195 shown in FIG. 2A). The back plate 170 is fitted in the back opening to separate and electric wires and allow them to pass toward the rear end of the connector body 102. The base tray 118 includes two holders 117 in its back corners for receiving and securing the positioning pillars 115 of the switch panel 112.

The female connector 198 further includes the electrical receptacle portion 180. As illustrated in FIG. 1B, the electrical receptacle portion 180 includes a first receptacle terminal 182a having a pair of metal gripping tongues (e.g., having an inner gripping tongue 185a and an outer gripping tongue 187a), a second receptacle terminal 182b having a pair of metal gripping tongues (e.g., an inner gripping tongue 185b and an outer gripping tongue 187b), and a ground terminal 186 having a metal sleeve. The receptacle terminals 182a and 182b and the ground terminal 186 are configured to receive the prongs of a male connector for electrical connection. As shown in FIG. 1B, the first receptacle terminal 182a is electrically and mechanically coupled to a first wire 184a, and the second receptacle terminal 182b is electrically and mechanically coupled to a second wire 184b. The ground terminal 186 is electrically and mechanically coupled to a ground wire 188.

The back plate 170 is fitted in the back opening 195 of the base tray 118. The back plate 170 includes a divider 172 for separating the wires 184a and 184b, a back wall 174, and a tunnel 176 for the ground wire 188 to pass through.

FIG. 2A illustrates a schematic exploded view of the built-in locking mechanism 110 shown in FIGS. 1A and 1B, in accordance with an example implementation of the present disclosure. FIG. 2B illustrates another schematic exploded view of the built-in locking mechanism 110 shown in FIGS. 1A and 1B, in accordance with an example implementation of the present disclosure.

As illustrated in FIGS. 2A and 2B, the top portion 122 and the bottom portion 126 of the control component 114 are fixedly joined by the shaft 124. When assembled, the control knob 123 is situated above the support deck 113 within the guard rail 162. The control knob 123 is confined in the area defined by the guard rail 162, and can slide in the sliding slot 120.

In the present implementation, the shaft 124 fits vertically through the sliding slot 120. The shaft 124 rigidly connects the top portion 122 and the bottom portion 126, allowing synchronized movement of the control component 114 above and beneath the switch panel 112. The coupled motion between the top portion 122 and the bottom portion 126 enables the user to control the built-in locking mechanism 110 via the control knob 123 on the exterior of the connector body 102.

The bottom portion 126 includes a pair of locking arms 128 and a pair of positioning levers (or sliders) 129. The locking arms 128 point forward (e.g., toward the front plate 106). Each locking arm 128 includes a vertical groove 131 on the outer side surface thereof. The vertical grooves 131 are fitted to engage and disengage with the vertical protrusions 135 on the inner surfaces of the jaws 132. It should be noted that, in another implementation, instead of having the locking arms 128, the bottom portion 126 may include a solid block having the vertical grooves 131 for interlocking with the vertical protrusions 135 of the jaws 132. The positioning levers 129 point backward (e.g., away from the front plate 106). Each of the positioning levers 129 includes a raised bump at the distal end thereof.

In the present implementation, in addition to the components described with reference to FIGS. 1A and 1B above, the switch panel 112 further includes a first pair of grooves 130a and a second pair of grooves 130b, where each pair substantially extends along the y-direction on the bottom surface of the support deck 113. The bumps at the distal ends of the positioning levers 129 can be slid in and out of the grooves 130a or 130b. For example, when the bumps at the distal ends of the positioning levers 129 are in the grooves 130a, the control component 114 is in the first resting position (e.g., the unlocked position), and the built-in locking mechanism 110 is in the unlocked state.

When the control knob 123 is pushed forward in the sliding slot 120, the bumps at the distal ends of the positioning levers 129 are moved out of the grooves 130a and slid into the grooves 130b (e.g., through elastic deformation of the positioning levers 129). As such, the control component 114 comes to the second resting position (e.g., the locked position), and the built-in locking mechanism 110 is in the locked state.

It is noted that, the grooves 130a and 130b facilitate the retention of the built-in locking mechanism 110 in the respective unlocked and locked positions, thereby inhibiting unintended movement of the control component 114 even if the user releases his/her finger from the control knob 123.

As illustrated in FIGS. 2A and 2B, the jaws 132 of the locking component 116 are coupled to the connecting member 136. The jaws 132 substantially extend along the x-direction and are separated by an opening 133. The jaws 132 each include an inner surface and an outer surface, where each inner surface includes a vertical protrusion 135, and each outer surface includes a protrusion (or bump) 134. In addition, the distal end of each jaw 132 is configured with a beveled inner surface to facilitate the insertion and extraction of the locking arms 128.

The connecting member 136 includes a recess 137. The base tray 118 includes a positioning pillar 119 and a stopper 166 to firmly fasten the connecting member 136 to the base tray 118. When assembled, the positioning pillar 119 is inserted into the recess 137 in the connecting member 136.The front wall 164 and the stopper 166 of the base tray 118 form a space that conforms to the outer shape of the connecting member 136. As such, the locking component 116 can be securely fastened to the base tray 118.

When the control knob 123 is pushed forward to the locked position, the coupled motion moves the locking arms 128 of the control component 114 into the opening 133. As a result, the vertical protrusions 135 on the jaws 132 are engaged with the vertical grooves 131 on the locking arms 128, and the bottom portion 126 is retained between the jaws 132. As the bottom portion 126 is inserted into the opening 133, the locking arms 128 push and bend the jaws 132 outward, for example, through elastic deformation. The outward deflections of the jaws 132 in turn cause the protrusions 134 on the outer surface of the jaws 132 to press against the inner gripping tongues 185a and 185b, firmly retaining the male connector prongs within the receptacle terminals 182a and 182b (as shown in FIG. 4B).

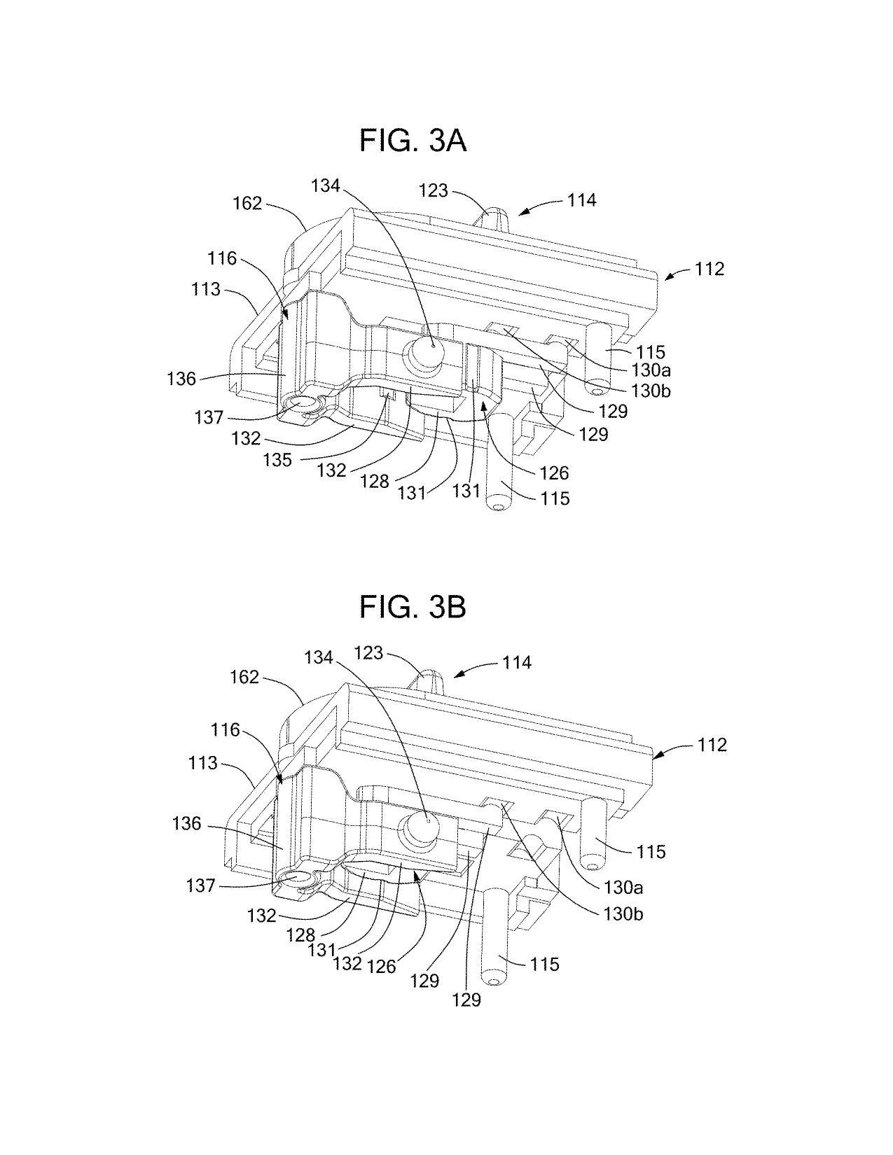

FIG. 3A illustrates a schematic view of portions of the built-in locking mechanism 110 in an unlocked position, in accordance with an example implementation of the present application. FIG. 3B illustrates a schematic view of portions of the built-in locking mechanism 110 in a locked position, in accordance with an example implementation of the present application.

In FIG. 3A, the control component 114 is in the unlocked position. The bumps on the distal ends of the positioning levers 129 rest in the grooves 130a on the bottom surface of the support deck 113. In the unlocked position, the bottom portion 126 of the control component 114 is not engaged (e.g., not in contact) with the jaws 132 of the locking component 116. The jaws 132 are in their neutral position, not subject to any external force or elastic deformation.

In FIG. 3B, the control component 114 is in the locked position. For example, the user pushes the control knob 123 forward (e.g., toward the front plate 106). As a result, the bumps on the distal ends of the positioning levers 129 are brought out of the grooves 130a and slid into the grooves 130b on the bottom surface of the support deck 113. In the locked position, the bottom portion 126 of the control component 114 is engaged (e.g., in contact) with the jaws 132 of the locking component 116. The jaws 132 are pushed by the locking arms 128 thereby bending outward. As a result, the protrusions 134 of the jaws 132 press against the inner gripping tongues 185a and 185b, firmly retaining the male connector prongs within the receptacle terminals 182a and 182b.

FIG. 4A illustrates a schematic view of a male connector 150 and portions of the built-in locking mechanism 110 of the female connector shown in FIGS. 1A and 1B in an unlocked state, in accordance with example implementations of the present disclosure. FIG. 4B illustrates a schematic view of the male connector 150 and portions of the built-in locking mechanism 110 of the female connector shown in FIGS. 1A and 1B in a locked state, in accordance with example implementations of the present disclosure.

As shown in FIGS. 4A and 4B, the male connector 150 includes prongs 152a and 152b and a ground prong 154, made of electrically conductive material for conducting electric current. The front openings 142a and 142b are aligned with the receptacle terminals 182a and 182b, respectively, for receiving the prongs 152a and 152b of the male connector 150.

As illustrated in FIG. 4A, the built-in locking mechanism 110 is in the unlocked state. The locking component 116 is situated near the front of the base tray 118. For example, the connecting member 136 of the locking component 116 is firmly fastened to the base tray 118 in the space between the front wall 164 and the stopper 166, where the recess 137 of the locking component 116 is faced down and so arranged that the positioning pillar 119 fits into the recess 137. As a result, the locking component 116 is securely attached to the base tray 118.

With the built-in locking mechanism 110 in the unlocked state, the bumps at the distal ends of the positioning levers 129 rest in the grooves 130a. The bottom portion 126 of the locking component 116 is in the unlocked position. The locking arms 128 are positioned near the back plate 170. The control component 114 and the locking component 116 are physically separate. In other words, the jaws 132 and the bottom portion 126 are not in contact. The vertical protrusions 135 are not engaged with the vertical grooves 131. The protrusion 134 on each of the jaws 132 does not make contact with the inner gripping tongue 185a/185b.

The divider 172 and the back wall 174 of the back plate 170 physically separate the receptacle terminals 182a and 182b, and allow them to exist from the back opening 195.

As illustrated in FIG. 4B, the prongs 152a and 152b of the male connector 150 are inserted into the receptacle terminals 182a and 182b, respectively, of the female connector (e.g., the female connector 198 in FIGS. 1A and 1B). The receptacle terminals 182a and 182b each have a pair of tongues (e.g., an inner gripping tongue and an outer tongue) for holding the prongs 152a and 152b, respectively.

In FIG. 4B, the built-in locking mechanism 110 is in the locked position. For example, the control knob 123 (e.g., shown in FIG. 3B) of the control component 114 is pushed forward to the locked position. The coupled motion of the top portion 122 and the bottom portion 126 moves the locking arms 128 and the positioning levers 129 into their locking positions. For example, the protrusions at the distal ends of the positioning levers 129 are slid into the grooves 130b (shown in FIG. 3B) and are retained therein. In addition, the locking arms 128 are pushed forward into the opening 133 between the jaws 132. As a result, the vertical protrusions 135 on the inner surfaces of the jaws 132 are engaged with the vertical grooves 131 on the outer surfaces of the locking arms 128, thereby interlocking the locking arms 128 with the jaws 132 and further stabilizing the assembly in the locking position.

The locking arms 128 in the locking position push the jaws 132 outward toward the receptacle terminals 182a and 182b. As the jaws 132 are bent by the insertion of the locking arms 128, the protrusions 134 on the exterior surface of the jaws 132 make contact with the inner gripping tongues 185a and 185b in the recesses 183a and 183b, respectively. The recesses 183a and 183b can hold the protrusions 134 in place and prevent them from moving.

In one implementation, each of the recesses 183a and 183b does not extend through the entire thickness of the inner gripping tongue 185a/185b. The protrusions 134 push outward against the inner gripping tongues 185a and 185b in recesses 183a and 183b, respectively. The inner gripping tongues 185a and 185b in turn press against and firmly secure the prongs 152a and 152b in their respective receptacle terminals 182a and 182b.

In another implementation, each of the recesses 183a and 183b extends through the entire thickness of the inner gripping tongue 185a/185b. In other words, the recesses 183a and 183b are through holes in the inner gripping tongues 185a and 185b. As the protrusions 134 push outward, they extend through the through holes in the inner gripping tongues 185a and 185b and make direct contact with the prongs 152a and 152b, respectively, to secure the prongs 152a and 152b in their respective receptacle terminals 182a and 182b.

As a result of the forces exerted on the prongs 152a and 152b by the protrusions 134 (e.g., either directly or indirectly through the inner gripping tongues 185a and 185b), the prongs 152a and 152b are firmly secured within the receptacle terminals 182a and 182b, respectively, ensuring a secure connection between the male and female connectors and resisting any external forces that may cause disengagement.

From the above description, it is manifest that various techniques can be used for implementing the concepts described in the present disclosure without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present disclosure is not limited to the particular implementations described above, but many rearrangements, modifications, and substitutions are possible without departing from the scope of the present disclosure.

What is claimed is:

1. A power cord female connector, comprising:
a casing;
at least one receptacle terminal, provided in the casing, for receiving at least one prong from a male connector;
a built-in locking mechanism, provided in the casing, for securing the at least one prong of the male connector to the at least one receptacle terminal, the built-in locking mechanism comprising:
a control component having a top portion and a bottom portion connected to the top portion;
a locking component having at least one jaw;
wherein, when the control component is in a locked position, the bottom portion of the control component pushes the at least one jaw against the at least one prong so as to secure the at least one prong in the at least one receptacle terminal.

2. The power cord female connector of claim 1, wherein, when the control component is in an unlocked position, the bottom portion of the control component is disengaged from the at least one jaw such that the at least one jaw is released from the at least one receptacle terminal.

3. The power cord female connector of claim 1, wherein:
the at least one jaw comprises a protrusion on an outer surface of the at least one jaw;
in the locked position, the protrusion makes contact with the at least one prong through a through-hole in an inner gripping tongue of the at least one receptacle terminal.

4. The power cord female connector of claim 1, wherein:
the at least one jaw comprises a vertical protrusion on an inner surface of the at least one jaw;
the bottom portion of the control component comprises at least one locking arm, the at least one locking arm having a vertical groove on an outer surface of the at least one locking arm;
in the locked position, the vertical protrusion is engaged with the vertical groove to interlock the at least one locking arm with the at least one jaw.

5. The power cord female connector of claim 1, wherein:
the bottom portion of the control component comprises at least one locking arm;
when the control component is in the locked position, the at least one locking arm is engaged with the locking component and causes the at least one jaw to bend outward through elastic deformation.

6. The power cord female connector of claim 1, wherein:
the built-in locking mechanism further comprises a switch panel fitted in an aperture on the casing;
the top portion is connected to the bottom portion through a shaft;
the top portion is situated above the switch panel, the bottom portion is situated below the switch panel, and the shaft is slidably fitted in a sliding slot of the switch panel.

7. The power cord female connector of claim 6, wherein:
the bottom portion comprises at least one positioning lever;
when the control component is in the locked position, the at least one positioning lever is engaged with a groove on a bottom surface of the switch panel.

8. The power cord female connector of claim 1, wherein:
the built-in locking mechanism further comprises a base tray for housing the at least one receptacle terminal, the locking component, and the bottom portion of the control component.

9. A power cord, comprising:
a power cable;
a female connector coupled to the power cable;
wherein the female connector comprises:
a casing;
at least one receptacle terminal, provided in the casing, for receiving at least one prong from a male connector;
a built-in locking mechanism, provided in the casing, for securing the at least one prong of the male connector to the at least one receptacle terminal, the built-in locking mechanism comprising:
a control component having a top portion and a bottom portion connected to the top portion;
a locking component having at least one jaw;
wherein, when the control component is in a locked position, the bottom portion of the control component pushes the at least one jaw against the at least one prong so as to secure the at least one prong in the at least one receptacle terminal.

10. The power cord of claim 9, wherein, when the control component is in an unlocked position, the bottom portion of the control component is disengaged from the at least one jaw such that the at least one jaw is released from the at least one receptacle terminal.

11. The power cord of claim 9, wherein:
the at least one jaw comprises a protrusion on an outer surface of the at least one jaw;
in the locked position, the protrusion makes contact with the at least one prong through a through-hole in an inner gripping tongue of the at least one receptacle terminal.

12. The power cord of claim 9, wherein:
the at least one jaw comprises a vertical protrusion on an inner surface of the at least one jaw;
the bottom portion of the control component comprises at least one locking arm, the at least one locking arm having a vertical groove on an outer surface of the at least one locking arm;
in the locked position, the vertical protrusion is engaged with the vertical groove to interlock the at least one locking arm with the at least one jaw.

13. The power cord of claim 9, wherein:
the bottom portion of the control component comprises at least one locking arm;
when the control component is in the locked position, the at least one locking arm is engaged with the locking component and causes the at least one jaw to bend outward through elastic deformation.

14. The power cord of claim 9, wherein:
the built-in locking mechanism further comprises a switch panel fitted in an aperture on the casing;
the top portion is connected to the bottom portion through a shaft;
the top portion is situated above the switch panel, the bottom portion is situated below the switch panel, and the shaft is slidably fitted in a sliding slot of the switch panel.

15. The power cord of claim 14, wherein:
the bottom portion comprises at least one positioning lever;
when the control component is in the locked position, the at least one positioning lever is engaged with a groove on a bottom surface of the switch panel.

16. The power cord of claim 9, wherein:
the built-in locking mechanism further comprises a base tray for housing the at least one receptacle terminal, the locking component, and the bottom portion of the control component.

17. A power cord female connector, comprising:
a casing;
a pair of receptacle terminals, provided in the casing, for receiving a pair of prongs of a male connector;
a built-in locking mechanism, provided in the casing, for securing the pair of prongs to the pair of receptacle terminals, the built-in locking mechanism comprising:
a switch panel fitted in an aperture on the casing;
a control component having a top portion and a bottom portion connected to the top portion through a shaft, the top portion situated above the switch panel, the bottom portion situated below the switch panel, the shaft being fitted in a sliding slot of the switch panel;
a locking component having a pair of jaws connected by a connecting member;
a base tray housing the pair of receptacle terminals, the locking component, and the bottom portion of the control component;
wherein, when the control component is in a locking position, a pair of locking arms of the bottom portion pushes the pair of jaws of the locking component against the pair of prongs so as to secure the pair of prongs of the male connector in the receptacle terminals.

18. The power cord female connector of claim 17, wherein:
when the control component is in a unlocked position, the pair of locking arms of the locking component is disengaged from the pair of jaws such that the pair of jaws does not exert a force on the pair of receptacle terminals.

19. The power cord female connector of claim 17, wherein:
each of the pair of jaws comprises a protrusion;
in the locked position, each of the protrusions makes contact with a respective one of the pair of prongs through a through-hole in an inner gripping tongue of the respective one of the pair of receptacle terminals.

20. The power cord female connector of claim 17, wherein:
each of the pair of jaws comprises a vertical protrusion on an inner surface of the corresponding jaw;
each of the pair of locking arms comprises a vertical groove on an outer surface of the corresponding locking arm;
in the locked position, the vertical protrusions are engaged with the vertical grooves to interlock the pair of locking arms with the pair of jaws.
